(19) United States
(12) Patent Application Publication
(10) Pub. No.: US 2007/0013949 A1
(43) Pub. Date: Jan. 18, 2007

(54) Network image forming device and user terminal device for displaying device information and method thereof

(75) Inventor: Soo-san Jeong, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/482,794

(22) Filed: Jul. 10, 2006

(30) Foreign Application Priority Data
Jul. 15, 2005 (KR) 2005-64156

(51) Int. Cl. G06F 3/12

(52) U.S. Cl. 358/1.15

(57) ABSTRACT

A network image forming device and a user terminal device are provided for displaying device information, via a network. The network image forming device for displaying device information comprises: a device information extracting unit for extracting at least one device information from printing function information and printing environment information; a display unit for displaying the extracted device information; and a control unit for controlling a visual display of selected device information from information extracted by the device information extracting unit. As a result, a user can easily obtain a variety of device information.

### CROSS-REFERENCE TO RELATED APPLICATIONS

This application claims all benefits accruing under 35 U.S.C. §119 from Korean Patent Application No. 2005-64156, filed Jul. 15, 2005, in the Korean Intellectual Property Office, the disclosure of which is incorporated by reference herein.

### BACKGROUND OF THE INVENTION

1. Field of the Invention

The present invention relates to an image forming device and a user terminal device in a network, and more particularly, relates to a network image forming device and a user terminal device for displaying device information and a method of displaying device information such as IP information selected by a user.

2. Related Art

In general, a printing system includes a user terminal device such as a host computer, and an image forming device such as a printer, a photocopier, a facsimile machine and a multi-functional product.

Typically, a user terminal device is connected directly to an image forming device to perform an image forming operation locally. However, as user terminal devices, such as computers, are becoming smaller, lighter, and more portable, and users are increasingly relying on wire or wireless networks, including the Internet, as sources of information and communication, including image forming operations, many user terminal devices can now access one or more image forming devices, via one or more networks.

Many network image forming devices that are recently launched have a predetermined communication module, typically in the form of a network interface card (NIC) or a network adapter installed, such that several user terminal devices or other network peripherals can share a single network image forming device through TCP/IP standard protocols (Network Internet Protocol). Such a network image forming device typically prints received print data from respective user terminal devices, via wire and/or wireless network.

The image forming device is typically provided with an IP address, to be accessed, via the wire and/or wireless network. The IP address provided to the image forming device is required not to overlap with IP addresses of other network devices including other image forming devices on the network. In addition, a user is required to know an IP address of a particular image forming device in order to use such a network image forming device on the network.

In order to confirm an IP address of a particular network image forming device, a user may print information page (or configuration sheet) or review an IP address-setting menu by manipulating a control panel of the image forming device.

In order to print the information page, the user is required to know how to use the network image forming device, and, likewise, in order to manipulate the control panel of the image forming device, the user needs to repeatedly search an IP address-setting menu. Accordingly, it is very inconvenient to confirm an IP address of a typical network image forming device.

### SUMMARY OF THE INVENTION

Several aspects and example embodiments of the present invention provide a network image forming device and a user terminal device for displaying device information and a method of providing user device information without-complexity, by displaying at least one device information selected by a user, all the time.

Additional aspects and/or advantages of the invention will be set forth in part in the description which follows and, in part, will be obvious from the description, or may be learned by practice of the invention.

In accordance with an embodiment of the present invention, a network image forming device for displaying device information comprises a device information extract unit arranged to extract at least one device information from printing function information and printing environment information; a display unit arranged to provide a visual display of extracted device information; and a control unit arranged to control the display unit to display the selected device information extracted by the device information extract unit.

According to an aspect of the present invention, the control unit may control the display unit to consistently display the device information selected until changed.

The printing function information may include current state information, memory information, network card information, IP (Internet Protocol) address, set option information, and consumable management information.

The consumable management information may include a remaining lifespan of a developing agent cartridge, a remaining lifespan of an OPC drum, a remaining lifespan of a developing unit, a remaining lifespan of a fixing unit, a remaining lifespan of a transferring unit, and a remaining lifespan of a pick-up roller.

The environment information may include printing menu information, printing quality information, paper manipulation menu information, composition menu information, network menu information, test menu information, and printing font information.

According to an aspect of the present invention, a user input unit is further provided for receiving from a user at least one device information from the printing function information and the printing environment information to be displayed on the display unit. The control unit may control the key input unit to receive a password from the user, via the user input unit, when the password is set at the extracted device information; and the display unit to provide a visual display of the device information when the password is correct. The control unit may also control the display unit to display a plurality of device information when the extracted device information contains more than two items.

In accordance with another embodiment of the present invention, a method of providing a visual display of device information on a network image forming device comprises: extracting at least one device information from printing function information and printing environment information; and displaying the device information selected from the extracted device information.

According to an aspect of the present invention, the device information selected is consistently displayed until changed. In addition, a password is required if the password is previously set at the extracted device information. As a result, the device information is only displayed when the password input is correct. When the extracted device information contains more than two items, a plurality of device information may be alternatively displayed.

In accordance with another embodiment of the present invention, a user terminal device for displaying device information comprises a driving unit arranged to control an image forming device to extract at least one device information from printing function information and printing environment information, and to provide a visual display of extracted device information; and an image forming device interface unit arranged to transmit a control signal generated by the driving unit to the image forming device to control the operation of the image forming device, including a visual display of extracted device information. The driving unit may further generate a control signal for controlling to alternatively display a plurality of device information when the device information contains more than two items.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram of an example network printing system;

FIG. 2 is a block diagram of an example network image forming device according to an embodiment of the present invention;

FIG. 3 illustrates an example panel of the network image forming device shown in FIG. 2;

FIGS. 4A through 4B illustrate example device information displayed on a display unit shown in FIG. 3;

FIG. 5 is a block diagram of an example user terminal device according to an embodiment of the present invention;

FIG. 6 is a flowchart of an action method of a network image forming device according to an embodiment of the present invention; and

FIG. 7 is a flowchart explaining the action method of a network image forming device according to the embodiment of the present invention.

### DETAILED DESCRIPTION OF EXAMPLE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

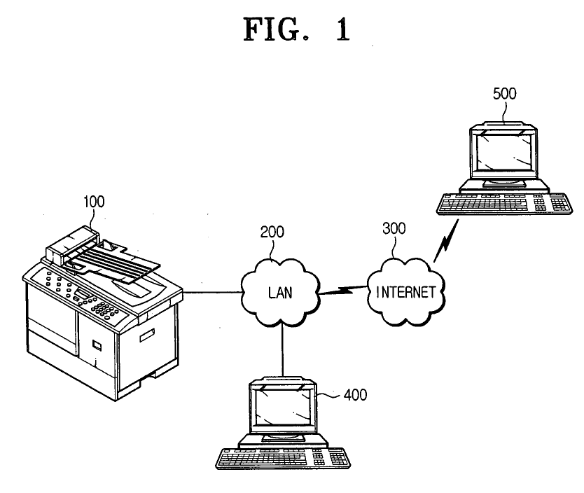

FIG. 1 is a block diagram of an example network printing system. As shown in FIG. 1, the network printing system comprises an image forming device 100 that is connected to a network, such as a local area network (LAN) 200 and an Internet 300, a first user terminal device 400 connected to the LAN 200 and a second user terminal device 500 connected to the LAN 200, via the Internet 300. Both the LAN 200 and the Internet 300 are packet-switch networks, such as Asynchronous Transfer Mode (ATM) networks, Ethernet or Frame Relay, in which network resources are shared and data in the form of data packets are routed independently across the networks along with other user traffic to a destination. Popular forms of communications across such networks include electronic mail, file transfer, web browsing, and other exchange of digital data including audio (e.g., voice) and multimedia (e.g., audio and video), via standard communication protocols, such as TCP/IP family of protocols (Transmission Control Protocol/Internet Protocol). The network 200 can also be a wireless network such as Wi-Fi, Bluetooth and ultra-wideband networks using compatible wireless application protocols for wireless transmission as specified by IEEE 802.11(a), (b) and/or (g) standards, Bluetooth standards and other emerging wireless personal area networks such as Wi-Max.

The first user terminal device 400 and the second user terminal device 500 can be personal computers (PCs) or workstations that are connected to the LAN 200, or via the Internet 300. In addition, other network peripherals such as mobile computers or personal digital assistants (PDA) can also be used to access the network image forming device 100, via wireless LAN 200.

The network image forming device 100 performs usual image forming operations, i.e., a printing function, and is provided with a predetermined communication module, such as a network interface card (NIC) or a network adapter, to access the LAN 200 and the Internet 300, and is further provided with its own IP address differentiated from other network devices on the networks. The IP address provided to the network image forming device 100 may be a dynamic IP address or a static IP address.

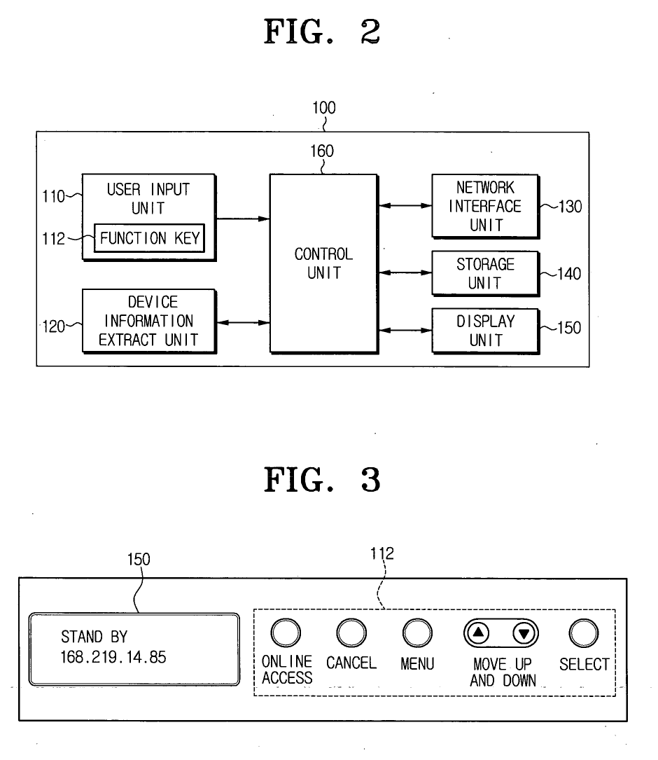

According to an embodiment of the present invention, the network image forming device 100 displays device information selected by a user on a display unit. The network image forming device 100 will be described in detail with reference to FIG. 2 later below.

The first user terminal device 400 is accessed to the network image forming device 100 through the LAN 200, and accessed to the second user terminal device 500 through the Internet 300. For printing, the first user terminal device 400 transmits a print command and print data to the network image forming device 100 through the LAN 200.

Similarly, the second user terminal device 500 is accessed to the network image forming device 100 and the first user terminal device 400 through the Internet 300. For printing, the second user terminal device 500 transmits a print command and print data to the network image forming device 100 through the Internet 300. The first user terminal device 400 and the second user terminal device 500 may transmit and receive predetermined data therebetween through the Internet 300.

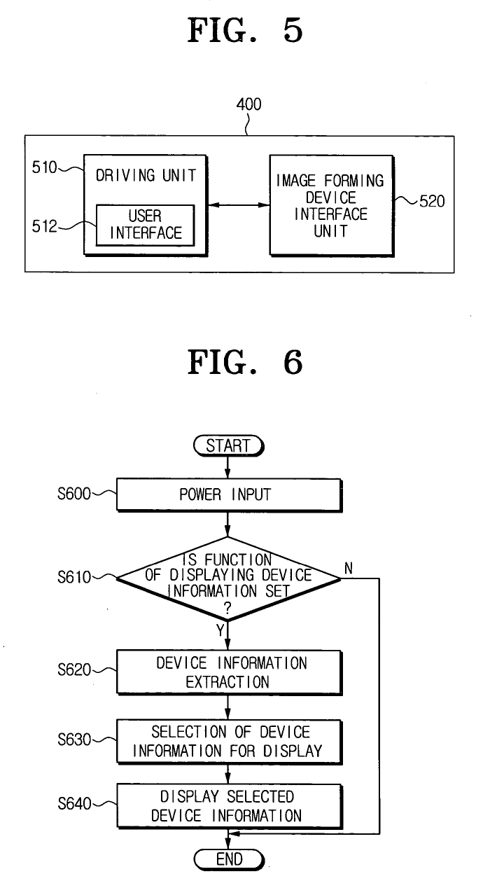

According to the embodiment of the present invention, the network image forming device 100 performs all the functions for displaying the device information. However, it is possible for the first and the second user terminal devices 400 and 500 to transmit control signals to control a visual display of the device information on the network image forming device 100, which will be described in detail with reference to FIG. 5 later below.

Turning now to FIG. 2, a block diagram of an example network image forming device according to an embodiment of the present invention is illustrated. Referring to FIG. 2, the network image forming device 100 comprises a user input unit 110, a device information extract unit 120, a network interface unit 130, a storage unit 140, a display unit 150, and a control unit 160.

The user input unit 110 is provided with a plurality of function keys 112, and receives at least one request signal from the user. When a password is set at device information, the user input unit 110 receives a password from the user and provides the password to the control unit 160.

The user may select and input the device information for a visual display on the display unit 150, via the user input unit 110.

The device information extract unit 120 extracts the device information preset under control of the control unit 160. The device information may include: (1) printing function information, and (2) printing environment information.

The printing function information may include a current state, memory information, network card information and consumable management information. The consumable management information may indicate a remaining lifespan of at least one of consumable items installed inside the network image forming device 100, including, for example, a developing agent cartridge, an organic photo-conductive (OPC) drum, a developing unit, and a fixing unit.

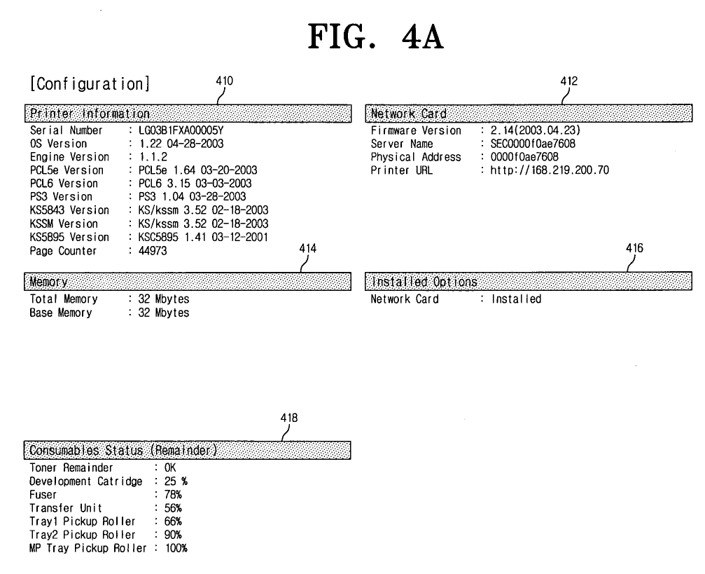

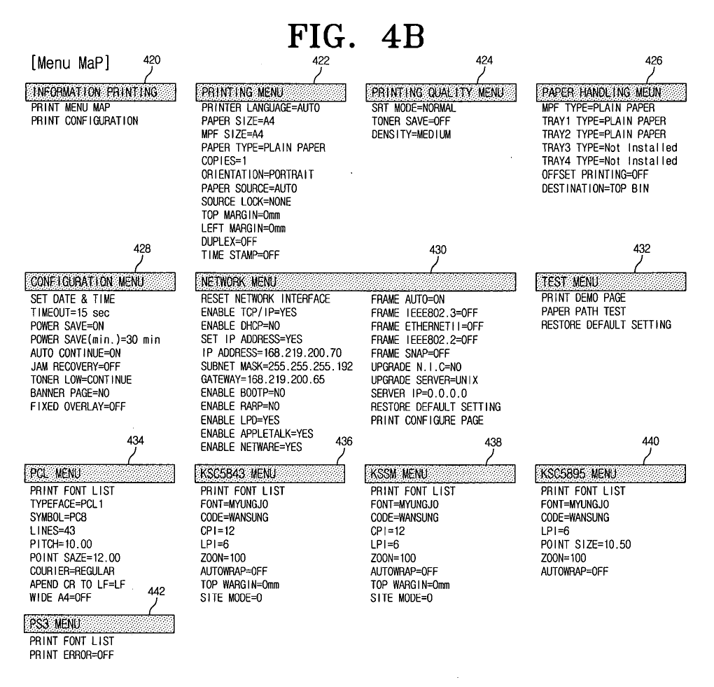

The printing environment information may include an IP address, printing menu information, printing quality information, paper manipulation menu information, composition menu information, network menu information, test menu information, printing font information, and printing page count. Specific examples of device information will be described in detail in connection with FIGS. 4A through 4B.

The device information extract unit 120 may extract corresponding device information from the storage unit 140. When consumable items (not shown) such as the developing agent cartridge, the OPC drum, the developing unit, and the fixing unit, have a memory set for each consumable, the device information extract unit 120 may extract the corresponding device information from the memory at the consumable items.

The network interface unit 130 provides an interface with the network, that is, the LAN 200 and/or the Internet 300. The network image forming device 100 is provided with an IP address differentiated from other network devices, to access the network. Such a network interface unit 130 can be a network interface card (NIC) or a network adapter installed to function as an interface between the network image forming device 100 and the network cabling.

The storage unit 140 includes a non-volatile memory for storing various control programs needed for embodying a function of the network image forming device 100, and a volatile memory for temporarily storing data generated during program execution of the control unit 160.

The storage unit 140 stores the IP address with which the network image forming device 100 to access the network through the network interface unit 130. The storage unit 140 stores (1) the printing function information and (2) the printing environment information. For example, the storage unit 140 may store management information such as the lifespan of the consumable items installed in the network image forming device 100.

The display unit 150 displays predetermined information under control of the control unit 160. According to an embodiment of the present invention, information displayed on the display unit 150 may include a current state of the network image forming device 100, for example, either a “standby” or “printing” state, and display device information extracted by the device information extract unit 120. A “standby” state is a state of waiting for printing data to be transmitted from the first and second terminal devices 400 and 500, and a “printing” state is a state of printing the printing data received from either the first or the second user terminal device 400 or 500.

The control unit 160 controls overall operations of the network image forming device 100, and controls signal input and output among the user input unit 110, the device information extract unit 120, the network interface unit 130, the storage unit 140, and the display unit 150.

The control unit 160 determines whether a device information displaying function is set or not, when power is input into the network image forming device 100. If the device information displaying function is set, the control unit 160 controls the device information extract unit 120 to extract the corresponding device information. If the device information is extracted by the device information extract unit 120, the control unit 160 controls the display unit 150 to provide a visual display of the device information selected of the extracted device information.

The control unit 160 also determines if the network image forming device 100 is accessed to the network through the network interface unit 130, and controls a visual display of the device information extracted by the device information extract unit 120 on the display unit 150 when the image forming device 100 is accessed to the network.

The control unit 160 may also control the display unit 150 to display a message to induce a user to input a password, when the password is set at the device information extracted by the device information extract unit 120. When the password is input into the user input unit 110, the control unit 160 may control a visual display of the device information extracted by the device information extract unit 120 on the display unit 150, only if the input password is correct.

The control unit 160 may control the display unit 150 to alternatively display a plurality of device information on the display unit 150 when the device information extracted by the device information extract unit 120 is more than a designated number, such as, for example, two (2), so that the plurality of device information can be easily recognized.

FIG. 3 illustrates an example control panel of the network image forming device shown in FIG. 2. As shown in FIG. 3, the control panel is provided with a display unit 150 for displaying a current state of the network image forming device 100 and predetermined device information, and a plurality of discrete function keys 112 for receiving a predetermined requesting signals and password selected by the user.

As illustrated in FIG. 3, the display unit 150 displays a “standby” state which is the current state of the network image forming device 100. There is an IP address provided by the network image forming device 100, for example, “168.219.14.85” on the lower side of the display unit 150 for displaying the current state. Such an IP address can be displayed on the display panel 160 if the user pre-sets the IP address in advance. In addition, the user can also pre-set the remaining lifespan of consumable items, such as the developing agent cartridge to be displayed. If the user pre-sets the remaining lifespan of the developing agent cartridge to be displayed, the remaining lifespan of the developing agent cartridge will be displayed on the display unit 150 where the IP address is displayed.

The function keys 112 includes, for example, an “on-line connection” key, a “cancel” key, a “menu” key, a “up and down movement” key, and a “selection” key.

The “online connection” key is used to request connection of the network image forming device 100 to the network, including the LAN 200 and/or the Internet 300, and the “cancel” key is used to cancel operation corresponding to the “online connection” key. The “menu” key is used to display various functions provided from the network image forming device 100. The “up and down movement” key is used to move a cursor up and down to select menus when the menus are displayed on the display unit 150 by the “menu” key, and the “selection” key selects the menu where the cursor is located. In addition, the function keys 112 may further include number keys or letter keys to receive the password. Corresponding requesting signals are input into the control unit 160 through the user input unit 110 by the function keys 112, and the control unit 160 controls the device information extract unit 120, the network interface unit 130, the storage unit 140, and the display unit 150 to perform operations according to the received requesting signals.

FIGS. 4A through 4B show example device information, including (1) printing function information, and (2) printing environment information displayed on a display unit 150, as shown in FIG. 3.

In particular, FIG. 4A shows types of printing function information included in a general information page to be displayed on the display unit 150. As shown in FIG. 4A, such printing function information may include: current state printer information 410, network card information 412, memory information 414, installed option information 416, and consumable management information 418.

The current state printer information 410 may include, for example: serial number, OS version, engine version, PCL5e version, PCL6 version, PS3 version, KS5843 version, KSSM version, KS5895 version and page counter indicating a printing page count.

The network card information 412 may include a firmware version, a server name, a local connection address, and IP address (URL).

The memory information 414 may include an entire memory capacity and a remaining memory capacity. For example, the total memory is 32 Mbytes.

The installed option information 416 may include information on options installed at the network image forming device 100 such as the network card.

The consumable management information 418 may include the remaining lifespan of various consumable items, such as a developing agent, a cartridge, a fuser, a transferring unit and a pick-up roller.

FIG. 4B shows types of printing environment information included a general information page displayed on the display unit 150. The printing environment information may include printing information 420, printing menu information 422, printing quality menu information 424, paper handling menu information 426, configuration menu information 428, network menu information 430, test menu information 432, and printing font information such as PCL menu 434, KSC5843 menu 436, KSSM menu 438, KSC5895 menu 440 and PS3 menu which are included in the general menu map.

As shown in FIG. 4B, the printing menu information 422 may include setting values such as language setting information, paper size, MPF size, paper type, paper page, paper location, and printing space.

The printing quality information 424 may include SRT mode, application of developing agent saving mode, and developing agent density.

The paper handling menu information 426 may include MPF type, paper-supply cassette type, off-set printing application, and printing location of prints.

The configuration menu information 428 may include data and time setting, type-out time setting and a power saving mode.

The network menu information 430 may include an IP address, a gateway address and a subnet mask address.

The test menu information 432 may include a printing demo page and a printing route test, and the printing font information may include a printing font list and a current font setting value.

FIG. 5 is a block diagram of an example user terminal device according to an embodiment of the present invention. As previously described in connection with FIG. 2 and FIG. 3, the image forming device 100 performs all the functions of extracting and displaying the device information. However, a user terminal device generates and transmits control signals for controlling the network image forming device 100 to extract the device information. Referring to FIG. 1, it is possible that both the first and the second user terminal devices 400 and 500 can generate and transmit these control signals; however, for purposes of brevity, only the first user terminal device 400 is described to perform these functions.

For example, as shown in FIG. 5, the first user terminal device 400 includes a driving unit 510 and an image forming device interface unit 520.

The driving unit 510 generates control signals for controlling operation of the network image forming device 100, including to extract at least one device information from one of the printing function information and the printing environment information, and to display the device information extracted by the network image forming device 100 on the display unit 150.

The driving unit 510 provides a user interface 512 for supporting an interface with the user. The user may select the device information to display on the display unit 150 of the network image forming device 100, through the user interface 512. According to an embodiment of the present invention, the driving unit 510 can be an operating system (OS) such as Unix, Linux, Windows, MacOS, and Solaris. The user interface 512 can be a graphical user interface (GUI).

The image forming device interface unit 520 supports interface between the first user terminal device 400 and the network image forming device 100, and transmits the control signals generated by the driving unit 510 to the network image forming device 100.

Likewise, if the first user terminal device 400 extracts the device information and transmits the control signals so as to display the extracted device information, the control unit 160 of the network image forming apparatus 100 controls the device information extract unit 120 to extract the device information and the display unit 150 to display the extracted device information.

FIG. 6 is a flowchart of a method of providing a visual display of selected device information on a network image forming device according to an embodiment of the present invention.

Referring to FIGS. 1 through 3, and FIG. 6, the method of providing a visual display of selected device information on the network image forming device 100 will be described herein below.

The network image forming apparatus 100 receives power at block S600. If the network image forming apparatus starts operating with received power, the control unit 160 determines if a function of displaying the device information is pre-set by a user at block S610.

If the function of displaying the device information is pre-set by a user at block S610, the control unit 160 controls the device information extract unit 120 to extract the device information at block S620.

After the device information is extracted by the device information extract unit 120, the control unit 160 controls the display unit 150 to display a device information list. The user then selects the device information for a visual display through the device information list displayed on the display unit 150 at block S630.

The control unit 160 controls the display unit 150 to display the device information selected by the user on the display unit 150. The display unit 150 then consistently displays the device information until the device information changes as per a user request at block S640.

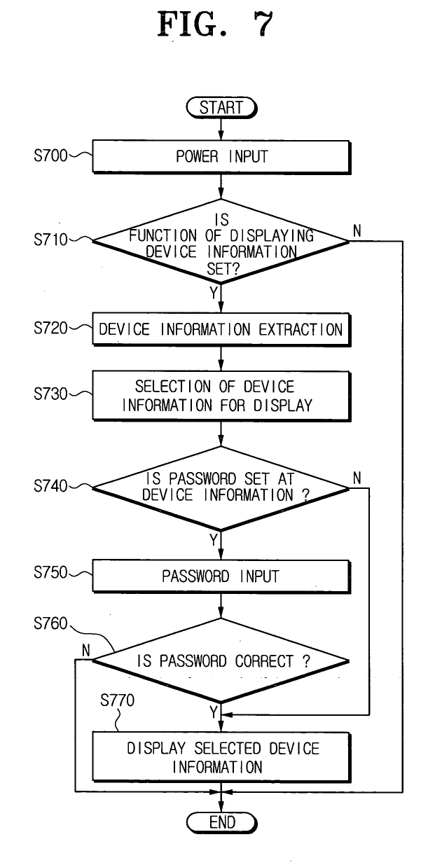

FIG. 7 is a flowchart of method of providing a visual display of selected device information on a network image forming device according to another embodiment of the present invention. Since block S600 through block S630 as shown in FIG. 6 are the same as block S700 through block S730, as shown in FIG. 7, the functions of those blocks need not be repeated herein.

At block S730, if the device information to be displayed is selected, the control unit 160 determines if a password is set at the device information selected by the user to be displayed on the display unit 150 at block S740.

At block S740, when the password is set for the extracted device information, the control unit 160 controls the display unit 150 to display a message for inducing the user to input the password. When the user inputs the password, the control unit 160 receives the password from the user input unit 110 at block S750.

After the password is input, the control unit 160 determines if the password received through the user input unit 110 matches a password set at the device information, that is, if the input password is correct at block S760. If the received password is correct, the control unit 160 controls the display unit 150 to consistently display the device information at block S770.

The user may receive his or her desired device information without separate manipulation. For example, the user may confirm various types of information on the network image forming device 100 as well as the IP address for accessing the network through the display unit 160. In addition, the user may also confirm the remaining lifespan of the consumable items, such as a developing agent cartridge, to know when to replace, in advance.

As described according to an embodiment of the present invention, the network image forming device and the user terminal device for displaying device information and the action method thereof, do not require complicated procedures for a user to receive the device information, by extracting at least one device information selected by the user and consistently displaying on the display unit.

It is also possible to know when to replace the consumable, by confirming the remaining lifespan of the consumable items, such as the developing agent cartridge, so that the user can prepare for any possible problem caused by abruptly expired lifespan of the consumable items.

While the invention has been shown and described with reference to certain embodiments thereof, it will be understood by those skilled in the art that various changes in form and details may be made therein without departing from the spirit and scope of the invention. Many modifications, permutations, additions and sub-combinations may be made to adapt the teachings of the present invention to a particular situation without departing from the scope thereof. For example, the components of the network image forming device, as shown in FIG. 2, can be implemented differently, as long as device information can be conveniently made available to a user in the manner described. Accordingly, it is intended, therefore, that the present invention not be limited to the various example embodiments disclosed, but that the present invention includes all embodiments falling within the scope of the appended claims.

What is claimed is:

1. A network image forming device for displaying device information comprising:
a device information extract unit arranged to extract at least one device information from printing function information and printing environment information;
a display unit arranged to provide a visual display of extracted device information; and
a control unit configured to provide a visual display of selected device information from the device information extracted by the device information extract unit.

2. The network image forming device as claimed in claim 1, wherein the control unit controls the display unit to consistently display the device information selected until changed.

3. The network image forming device as claimed in claim 1, wherein the printing function information comprises current state information, memory information, network card information, IP (Internet Protocol) address, set option information, and consumable management information.

4. The network image forming device as claimed in claim 3, wherein the consumable management information comprises a remaining lifespan of a developing agent cartridge, a remaining lifespan of an OPC drum, a remaining lifespan of a developing unit, a remaining lifespan of a fixing unit, a remaining lifespan of a transferring unit, and a remaining lifespan of a pick-up roller.

5. The network image forming device as claimed in claim 1, wherein the printing environment information comprises printing menu information, printing quality information, paper manipulation menu information, composition menu information, network menu information, test menu information, and printing font information.

6. The network image forming device as claimed in claim 1, further comprising:
a user input unit for receiving from a user at least one device information from the printing function information and the printing environment information for a visual display on the display unit.

7. The network image forming device as claimed in claim 6, wherein the control unit controls the user input unit to receive a password input from the user through the user input unit, when the password is set at the extracted device information, and the display unit to display the device information when the input password is correct.

8. The network image forming device as claimed in claim 1, wherein the control unit controls the display unit to display a plurality of device information when the extracted device information contains more than two different items.

9. A method of a network image forming device for displaying device information comprising:
extracting at least one device information from printing function information, and printing environment information; and
displaying the device information selected from the extracted device information.

10. The method as claimed in claim 9, wherein the device information selected is consistently displayed until changed.

11. The method as claimed in claim 9, further comprising:
receiving a predetermined password from: a user when the password is set at the extracted device information,
wherein the device information is displayed only when the password is correct.

12. The method as claimed in claim 9, wherein a plurality of device information are alternatively displayed, when the extracted device information contains more than two items.

13. A user terminal device for displaying device information comprising:
a driving unit arranged to control an image forming device to extract at least one device information from printing function information and printing environment information, and to provide a visual display of extracted device information; and
an image forming device interface unit arranged to transmit a control signal generated by the driving unit to the image forming device to control the operation of the image forming device, including a visual display of extracted device information.

14. The user terminal device as claimed in claim 13, wherein the driving unit further generates a control signal for controlling to alternatively display a plurality of device information when the device information contains more than two items.

15. A network printing system, comprising:
a network;
an image forming device arranged in communication with the network; and
one or more user terminal devices arranged to access the image forming device, via the network,
wherein the image forming device comprises a device information extract unit arranged to extract at least one device information from printing function information and printing environment information; and a control unit configured to provide a visual display of selected device information.

16. The network printing system as claimed in claim 15, wherein the printing function information comprises current state information, memory information, network card information, IP (Internet Protocol) address, set option information, and consumable management information.

17. The network printing system as claimed in claim 16, wherein the consumable management information comprises a remaining lifespan of a developing agent cartridge, a remaining lifespan of an OPC drum, a remaining lifespan of a developing unit, a remaining lifespan of a fixing unit, a remaining lifespan of a transferring unit, and a remaining lifespan of a pick-up roller.

18. The network printing system as claimed in claim 15, wherein the printing environment information comprises printing menu information, printing quality information, paper manipulation menu information, composition menu information, network menu information, test menu information, and printing font information.

19. The network printing system as claimed in claim 16, wherein the image forming device further comprises a user input unit for receiving from a user at least one device information from the printing function information and the printing environment information for a visual display on a display panel.

20. The network printing system as claimed in claim 16, wherein the control unit controls the user input unit to receive a password input from the user, when the password is set at the extracted device information, and the extracted device information is only displayed on a display panel when the input password is correct.

21. The network printing system as claimed in claim 16, wherein the network is one of a local area network (LAN) and a wireless local area network (WLAN).

22. The network printing system as claimed in claim 16, wherein the user terminal device comprises:
a driving unit arranged to control the image forming device to extract at least one device information from printing function information and printing environment information, and to provide a visual display of extracted device information; and
an image forming device interface unit arranged to transmit a control signal generated by the driving unit to the image forming device to control the operation of the image forming device, including a visual display of extracted device information.

23. The network printing system as claimed in claim 22, wherein the driving unit further generates a control signal for controlling to alternatively display a plurality of device information when the device information contains more than two items.
